(19) United States
(12) Patent Application Publication
(10) Pub. No.: US 2012/0099914 A1
(43) Pub. Date: Apr. 26, 2012

(54) Image forming apparatus and method for controlling the same

(75) Inventors: Jeong-yeon Park, Hwaseong-si (KR); Byung-sun Ahn, Suwon-si (KR)

(73) Assignee: SAMSUNG ELECTRONICS CO., LTD., Suwon-si (KR)

(21) Appl. No.: 13/200,367

(22) Filed: Sep. 23, 2011

(30) Foreign Application Priority Data
Oct. 26, 2010 (KR) 2010-0104726

(51) Int. Cl. B41J 11/42

(52) U.S. Cl. 400/582

(57) ABSTRACT

An image forming apparatus and method are provided. The apparatus includes an input unit receiving an input of print data, a print unit performing printing of the input print data, a feeder unit feeding a printing paper to the print unit, and a control unit controlling the feeder unit to feed the printing paper in a long-edge feed type or a short-edge feed type in accordance with a print mode set for the print data.

### CROSS-REFERENCE TO RELATED APPLICATIONS

This application is related to and claims priority to Korean Patent Application No. 2010-0104726, filed on Oct. 26, 2010, in the Korean Intellectual Property Office, the disclosure of which is incorporated herein by reference.

### BACKGROUND

1. Field

The embodiments disclosed herein are related to an image forming apparatus and a method for controlling the same, and more particularly, to an image forming apparatus of a multi-feed type and a method for controlling the same.

2. Description of the Related Art

Conventionally an image forming apparatus performs printing in a long-edge or short-edge feed mode.

For example, in performing printing in a long-edge feed mode, an A4-sized portrait paper may be fed, and a printing time of one second required in printing. In performing printing in a short-edge feed mode, an A4-sized paper may be fed, and a printing time of 1.5 seconds (one second×1.5) or more required in printing the paper in a horizontal direction.

In a case of a small amount of printing work, a difference in of several seconds between the printing in a long-edge feed mode and the printing in a short-edge feed mode, and does not greatly impact productivity. However, in a situation such as a Publish On Demand (POD) system, the printing work may be several thousands of papers. In this case, if the printing is performed in a long-edge feed mode, a printing time of 6000 seconds (6000 sheets×one second) is required to perform the whole printing. By contrast, if the printing is performed in a short-edge feed mode, a printing time of 9000 seconds (6000 sheets×1.5 seconds) is required to perform the entire printing task. Accordingly, the difference of about 3000 seconds greatly influences productivity.

In double-sided printing, a printing time of three seconds may be required per paper, which includes two seconds for performing single-sided printing on both sides of the paper (the front-side and the rear-side of the paper) and one second for re-feeding the paper for the double-sided printing (for duplexing). In a case of a small amount of duplex printing work, a difference is in a range of several seconds between the printing in a long-edge feed mode and the printing in a short-edge feed mode, and thus does not greatly impact productivity. However, in performing of a large amount of printing work through a large-scale printing system such as a POD system or a printing device, the difference greatly impacts printing performance.

### SUMMARY

It is an aspect of the embodiments discussed herein to address problems and/or disadvantages of conventional systems. and provide an image forming apparatus and a method for controlling the same, which can improve the printing performance.

According to an aspect of the present disclosure, an image forming apparatus includes an input unit receiving an input of print data, a print unit performing printing of the input print data, a feeder unit feeding a printing paper to the print unit, and a control unit controlling the feeder unit to feed the printing paper in a long-edge feed type or a short-edge feed type in accordance with a print mode set for the print data.

The control unit may control the feeder unit to feed the printing paper in the long-edge feed type upon the print mode set for the print data is a double-sided print mode and to feed the printing paper in the short-edge feed type upon the print mode set for the print data is a single-sided print mode.

The control unit may control the feeder unit to feed the printing paper in the long-edge feed type upon the print mode set for the print data is a high resolution print mode and to feed the printing paper in the short-edge feed type upon the print mode set for the print data is a low resolution print mode.

The image forming apparatus according to an exemplary embodiment of the present disclosure may include a user interface unit providing user information on at least one of a first required time for performing printing by feeding the printing paper in the short-edge feed type, a second required time for performing printing by feeding the printing paper in the long-edge feed type, and comparison data of the first required time and the second required time, in performing the printing of the print data.

The image forming apparatus according to an exemplary embodiment of the present disclosure may include a notification unit notifying a user that a paper setting state of the feeder unit is unfit for completing the printing in a feed type that corresponds to the set print mode, if the paper setting state is unfit for completing the printing.

According to another aspect of the present disclosure, an image forming apparatus includes an input unit receiving an input of print data; a user interface unit for setting a print mode for the print data, a print unit performing printing of the print data in accordance with a print mode set for the print data, a first loading unit loading papers being fed in a short-edge feed type-,; a second loading unit loading papers being fed in a long-edge feed type, and a control unit controlling the first loading unit or the second loading unit to feed the papers according to whether the set print mode is a double-sided print mode or a single-sided print mode.

The control unit may control the second loading unit to feed the papers upon the print mode for the print data being set to a double-sided print mode, and control the first lading unit to feed the papers upon the print mode for the print data being set to a single-sided print mode.

The image forming apparatus according to another exemplary embodiment of the present disclosure may include a sensor unit sensing a paper loading state that includes at least one of whether the papers are loaded on at least one of the first loading unit and the second loading unit and the number of the papers; wherein the control unit may include a notification unit notifying a user that a paper loading state of at least one of the first loading unit and the second loading unit is unfit for completing the corresponding printing work if the paper loading state is unfit for completing the printing work.

The user interface unit may provide a display window that provides user information on at least one of a first required time for the first loading unit to perform printing by feeding the paper, a second required time for the second loading unit to perform printing by feeding the paper, and comparison data of the first required time and the second required time, in performing the printing of the print data.

The user interface unit may provide an input window for resetting a feed type to the short-edge feed type or the long-edge feed type based on other printing works that include post-processing upon the printing work for the print data being set to the double-sided print mode or the single-sided print mode.

According to one aspect of the present disclosure, a method for controlling an image forming apparatus includes receiving an input of print data, confirming a print mode set for the print data, and feeding a printing paper in a long-edge feed type or a short-edge feed type in accordance with the print mode set for the print data.

The feeding operation may feed the printing paper in the long-edge feed type upon the print mode set for the print data is a double-sided print mode and may feed the printing paper in the short-edge feed type upon the print mode set for the print data is a single-sided print mode.

The feeding operation may feed the printing paper in the long-edge feed type upon the print mode set for the print data is a high resolution print mode and may feed the printing paper in the short-edge feed type upon the print mode set for the print data is a low resolution print mode.

The method for controlling an image forming apparatus according to an exemplary embodiment of the present disclosure may include providing user information on at least one of a first required time for performing printing by feeding the printing paper in the short-edge feed type, a second required time for performing printing by feeding the printing paper in the long-edge feed type, and comparison data of the first required time and the second required time, in performing the printing of the print data.

The method for controlling an image forming apparatus according to an exemplary embodiment of the present disclosure may include notifying a user that a paper setting state of the feeder unit is unfit for completing the printing in a feed type that corresponds to the set print mode if the paper setting state is unfit for completing the printing.

According to another aspect of the present disclosure, a method for controlling an image forming apparatus includes receiving an input of print data, a user interface unit for setting a print mode for the print data, setting a print mode for the print data, determining whether a first loading unit that loads papers being fed in a short-edge feed type or a second loading unit that loads papers being fed in a long-edge feed type feeds the papers according to whether the set print mode is a double-sided print mode or a single-sided print mode; and performing printing in accordance with the determined feed type.

The determination operation may determine that the second loading unit feeds the papers upon the print mode for the print data being set to a double-sided print mode, and the first lading unit feeds the papers upon the print mode for the print data being set to a single-sided print mode.

The method for controlling an image forming apparatus according to another exemplary embodiment of the present disclosure may include sensing a paper loading state that includes at least one of whether the papers are loaded on at least one of the first loading unit and the second loading unit and the number of the papers, and notifying a user that a paper loading state of at least one of the first loading unit and the second loading unit is unfit for completing the corresponding printing work if the paper loading state is unfit for completing the printing work.

The method for controlling an image forming apparatus according to another exemplary embodiment of the present disclosure may include providing a display window that provides user information on at least one of a first required time for the first loading unit to perform printing by feeding the paper, a second required time for the second loading unit to perform printing by feeding the paper, and comparison data of the first required time and the second required time, in performing the printing of the print data.

The method for controlling an image forming apparatus according to another exemplary embodiment of the present disclosure may include providing an input window for resetting a feed type to the short-edge feed type or the long-edge feed type based on other printing works that include post-processing upon the printing work for the print data being set to the double-sided print mode or the single-sided print mode.

### BRIEF DESCRIPTION OF THE DRAWINGS

The above and other aspects and advantages of the present disclosure will be more apparent from the following detailed description when taken in conjunction with the accompanying drawings, in which:

FIG. 1 illustrates a POD system according to an exemplary embodiment of the present disclosure;

FIG. 2 illustrates an image forming apparatus according to an exemplary embodiment of the present disclosure;

FIG. 3 illustrates an image forming apparatus according to another exemplary embodiment of the present disclosure;

FIGS. 4A and 4B illustrate feed types according to an exemplary embodiment of the present disclosure;

FIG. 5 illustrates an image forming apparatus according to an exemplary embodiment of the present disclosure;

FIG. 6 illustrates an operation unit of an image forming apparatus according to an exemplary embodiment of the present disclosure;

FIG. 7 illustrates a method for controlling an image forming apparatus according to an exemplary embodiment of the present disclosure; and

FIG. 8 illustrates a method for controlling an image forming apparatus according to another exemplary embodiment of the present disclosure.

### DETAILED DESCRIPTION

Exemplary embodiments of the present disclosure are described in detail with reference to the accompanying drawings

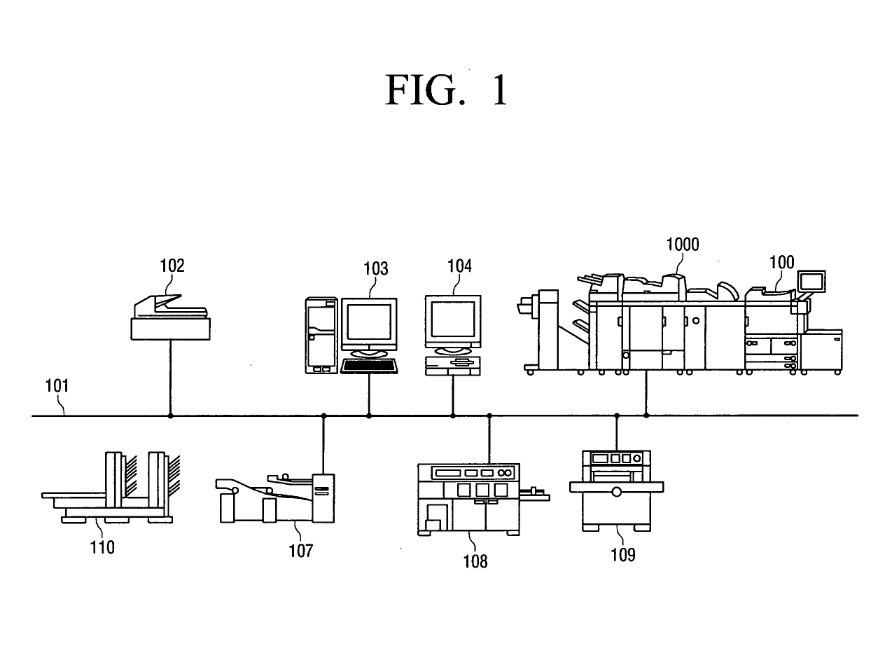

FIG. 1 illustrates a POD system according to an exemplary embodiment of the present disclosure.

An exemplary POD (Publish On Demand) system includes a printing system 1000, a scanner 102, a server computer (PC) 103, and a client computer 104, all of which may be connected through a network 101.

The POD system may include a finisher 107 that is a post-processing device capable of folding papers, a cover bookbinder 108, a cutter 109, and an intermediate bookbinder 110.

The server PC 103 manages data transmission/reception with various kinds of devices connected to the network 101. The client PC 104 uses the network 101, and transmits image data to a printing device 100 of the printing system 1000 or the server PC 103.

The finisher 107 performs folding and bookbinding process of the papers printed by the printing device 100.

The cover bookbinder 108 performs cover bookbinding process of the papers printed by the printing device 100.

The cutter 109 performs cutting of the papers printed by the printing device 100 by the bundle of papers.

The intermediate bookbinder 110 performs bookbinding of the papers printed by the printing device 100.

In this exemplary embodiment, the printing device 100 performs bookbinding, and thus functions as a bookbinding device. However, this is merely exemplary, and the present disclosure is not limited thereto. For example, it is also possible that the server PC 103, the client PC 104, or at least one of post-processing devices 107, 108, 109, and 110 may perform bookbinding.

In using the post-processing devices 107, 108, 109, and 110, a user may take out papers printed by the printing device 100 from the printing system 1000, and set the papers in the post-processing devices 107, 108, 109, and 110 so that the corresponding devices perform their processing.

Upon the papers being fed to a printing device other than printing device 100, the post-processing devices 107, 108, 109, and 110 can perform the post-processing in a similar manner.

According to an exemplary embodiment, a multifunction peripheral (MFP) having plural capabilities such as copying, printing, and the like, as the printing device, is disclosed. However, the printing device may be a single function type printing device having only performing copying function or printing.

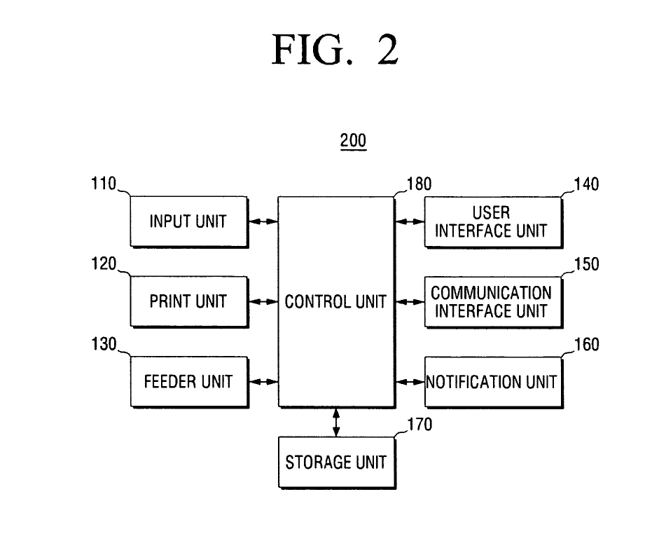

FIG. 2 illustrates an image forming apparatus according to an exemplary embodiment of the present disclosure.

Referring to FIG. 2, an image forming apparatus 200 includes an input unit 111, a print unit 120, a loading unit 130, a user interface unit 140, a communication interface unit 150, a notification unit 160, a storage unit 170, and a control unit 180. The image forming apparatus 200 may be implemented by the printing device 100 of FIG. 1.

The image forming apparatus 200 may be a multifunction peripheral (MFP) that multiply implements a scanner, a copy machine, a facsimile or their functions through one apparatus, or a 3D scanner.

The input unit 111 receives image data for image processing.

The input unit 111 may receive an input of a print image or a scan image and to generate the print image or the scan image. That is, the input unit 111 may receive an image that is generated through an application program or a driver provided in a host device 111 or an RGB rendering image that is generated through emulation. Also, in copying, the input unit 111 may receive an input of a scan image scanned by an RGB sensor. In this exemplary embodiment, for convenience in explanation, it is exemplified that the image forming apparatus 200 receives an image that is generated through an application program or a driver provided in a host device

An image forming unit may perform image processing with respect to input data under the control of the control unit 180.

For example, the image forming unit converts an 8-bit image having RGB colors by channels into an image having CMYK colors through a color conversion, performs image quality improvement with respect to the converted image, and generates a one-bit image (binary data) through half-toning.

The image processing unit may perform diverse image quality improvement processes such as blurring, trapping, sharpening, edge enhancement, and the like, with respect to the image which has been converted into the CMKY toner color. Since the detailed image processing operation of the image processing unit has no relation to the contents of the present disclosure, further detailed explanation thereof will be omitted.

The print unit 120 may print data that is image-processed by the image processing unit on a recording medium under the control of the control unit 180. For example, in the case of a laser type image forming apparatus, an OPC surface is charged by a charging unit, and on the charged area, a latent image is formed by an LSU. If development is formed by a development unit in this state, toner is attached to the latent image, and then is transferred to a paper by a transfer unit. The transferred toner is fused on the paper by a fusing unit. However, this is merely exemplary, and it is apparent to those of skilled in the art that the image forming apparatus according to an exemplary embodiment of the present disclosure may be of an ink jet type.

The print unit 120 may perform a print work in accordance with the set print mode. The print mode may be preset, or may be changed by a user's operation. The print mode may include a double-sided print mode and a single-sided print mode. The print mode may include a high image quality print mode and s low image quality mode.

The print unit 120 may perform a print work in a short-edge feed mode or a long-edge feed mode. The detailed explanation thereof will be made later.

The feeder unit 130 functions to feed a printing paper to the print unit 120. For example, the feeder unit 130 may be composed of a feeder cassette, a feeder deck, a tray, and the like.

The feeder unit 130 may be implemented to feed a paper in a short-edge feed mode or in a long-edge feed mode. For example, the feeder unit 130 may be implemented to include a first loading unit that loads papers being fed in a short-edge feed type and a second loading unit that loads papers being fed in a long-edge feed type. It is also possible that the feeder unit 130 is implemented to change the paper feed mode from the short-edge feed mode to the long-edge feed mode and vice versa (for example, to change the direction of the paper loading unit.

The user interface unit 140 may include operation keys for inputting user commands for controlling the operation of an image forming apparatus and a display window such as an LCD (Liquid Crystal Display) for displaying the state of the image forming apparatus. The user interface 140 may be implemented as a device that simultaneously performs input and output operations such as a touchpad or the like.

The user interface unit 140 may display various kinds of information provided from the image forming apparatus 200, job proceeding particulars performed by the image forming apparatus, and the result of job proceeding. A user can confirm various kinds of printing job in the image forming apparatus 200 and perform management control through the user interface 140.

The user interface 140 may provide through the display window at least one of a first required time for performing printing in the short-edge feed mode, a second required time for performing printing in the long-edge feed mode, and comparison data of the first required time and the second required time. Accordingly, the user can be provided with a visual feedback of the print required time according to the respective feed mode.

The communication interface unit 150 supports data communication with an external device through a network. For example, the communication interface unit 150 may be implemented in the form that can support a DLNA network, a local type, a LAN (Local Area Network), and the Internet. In particular, the communication interface unit 150 may receive and provide an application program provided in a host device, an image generated through a driver or the like, or an RGB rendering image generated through emulation or the like, to the input unit 111.

Although FIG. 2 illustrates the input unit 111 and the communication interface unit 150 as separate hardware configurations, it is merely one exemplary embodiment of the present disclosure, and it is also possible that the communication interface unit 150 is implemented as the input unit 111.

The notification unit 160 may notify a user upon it is difficult or impossible to perform printing of print data in the currently set feed mode.

The storage unit 170 may store various kinds of programs for the operations of the respective configuration elements of the image forming apparatus 200.

The storage unit 170 may store feed mode information according to the print mode. The storage unit 170 may store feeder modes that correspond to the double-sided print mode and the single-sided print mode. The storage unit 170 may store feeder modes that correspond to a high image quality print mode and a low image quality print mode. For example, the storage unit 170 may store information that are preset so as to print in a long-edge feed mode in the case of the double-sided print mode and to print in a short-edge feed mode in the case of the single-sided print mode. The storage unit 170 may store information that is preset so as to print in the long-edge feed mode in the case of the high image quality print mode and to print in the short-edge feed mode in the case of the low image quality print mode.

The storage unit 170 may be implemented by a storage medium in the image forming apparatus 200 and an external storage medium, for example, a removable disk including a USB memory, a storage medium connected to a host, a web server through a network, and the like.

The control unit 180 functions to control the operations of the respective configuration elements of the image forming apparatus 200.

The control unit 180 may control the operations of the input unit 110, the print unit 120 of an image forming unit, the feeder unit 130, the user interface unit 140, the communication interface unit 150, the notification unit 160, the storage unit 170, and the control unit 180.

The control unit 180 may operate to determine or change the paper feed type in accordance with the print mode that is set with respect to the print data input through the input unit 110.

For example, the control unit 180 may control the feeder unit 130 to feed the paper in the short-edge feed mode or in the long-edge feed mode in accordance with whether the print mode for the print data is set to the double-sided print mode or the single-sided print mode. The control unit 180 may control the feeder unit 130 to feed the paper in the short-edge feed mode or in the long-edge feed mode in accordance with whether the print mode for the print data is set to the high image quality print mode or the low image quality print mode.

The control unit may control the feeder unit 130 to feed the paper in the long-edge mode upon the print mode for the print data is set to the double-sided print mode, and to feed the paper in the short-edge mode upon the print mode for the print data is set to the single-sided print mode.

The user interface unit 140 may provide an operation unit that makes it possible to reset the short-edge feed mode or the long-edge feed mode based on another print work that includes a post-process upon the print mode for the print data is set to the double-sided print mode or the single-sided print mode.

It may be difficult to feed the papers set in the feeder unit 130 in the long-edge feed mode in a state where the print mode for the print data is set to the double-sided print mode, the notification unit 160 may notify the user of such a state. The case where it is difficult to feed the papers in the long-edge feed mode may be a case where there is no paper that is set to be fed in the long-edge feed mode, a case where there are insufficient papers for printing the corresponding print data, and the like. Where it may be difficult to feed the papers in the short-edge feed mode in a state where the print mode for the print data is set to the single-sided print mode, the notification unit may notify the user of such a state.

According to an exemplary embodiment, all the feed modes may be set according to the respective corresponding print modes. However, this is merely exemplary, and it is also possible to set the feed mode only with respect to one of the respective corresponding print modes. For example, it is also possible that in the double-sided print mode, the printing is performed in the long-edge feed mode, while in the single-sided print mode, the feed mode is determined randomly, in accordance with the user's setting, or as the same feed mode as that in the double-sided printing.

According to an exemplary embodiment, the above-described functions are controlled through the configuration elements provided in the image forming apparatus 200. However, this is merely exemplary, and all functions may be controlled through a printer driver or an application that is provided in the host device connected to the image forming apparatus 200.

According to an exemplary embodiment of the present disclosure, an appropriate control can be performed with respect to the printing in the long-edge feed mode and in the short-edge feed mode for each work to be processed. For example, where the print work to be processed is the double-sided print work based on the print condition set by the user, the printing may be processed in the long-edge mode to improve the productivity. Because of this, a system having an improved productivity can be provided.

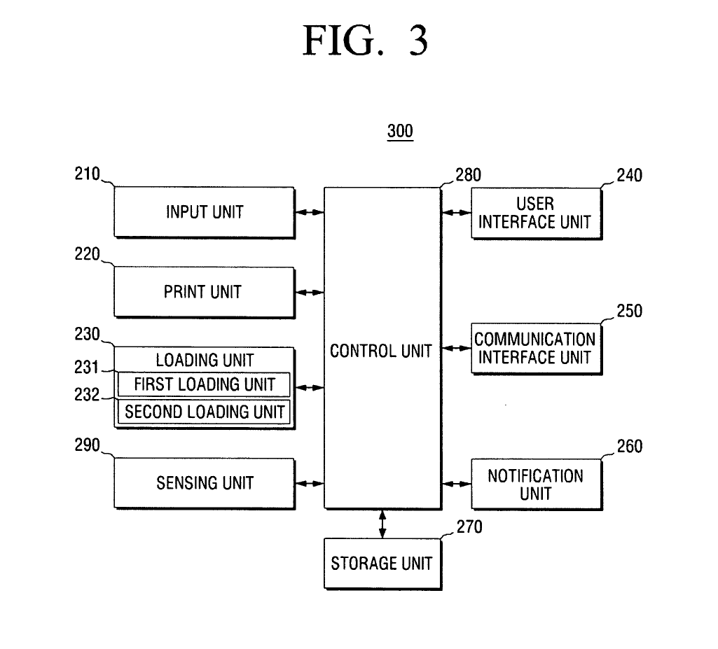

FIG. 3 illustrates an image forming apparatus according to another exemplary embodiment of the present disclosure.

Referring to FIG. 3, an image forming apparatus 300 includes an input unit 210, a print unit 220, first and second loading units 231 and 232, a user interface unit 240, a communication interface unit 250, a notification unit 260, a storage unit 270, a control unit 280, and a sensing unit 290. A detailed explanation of elements illustrated in FIG. 2 that are similar to elements illustrated in FIG. 1 is omitted.

The input unit 210 receives print data.

An image forming unit performs an image process for the input print data.

The print unit 220 performs a print work for the image-processed print data in a short-edge feed mode or in a long-edge feed mode.

The loading unit 230 loads papers for printing the print data, and may include a first loading unit 231 which loads papers that are fed in a short-edge feed mode direction and a second loading unit 232 which loads papers that are fed in a long-edge feed mode direction.

The user interface unit 240 may receive setting of the print mode for the print data. The print mode may include, but is not limited to, double-sided/single-sided print modes arid high image quality/low image quality print mode, and diverse print modes that exert an influence on the print speed may be included therein.

The user interface unit 240 may provide a display window that provides user information on at least one of a first required time for the first loading unit 231 to perform printing by feeding the paper, a second required time for the second loading unit 232 to perform printing by feeding the paper, and comparison data of the first required time and the second required time, in performing the printing of the print data.

The user interface unit 240 may provide an input window for resetting the feed type from the short-edge feed type to the long-edge feed type and vice versa based on another print work that includes a post-process upon the print mode for the print data is set to the double-sided print mode or the single-sided print mode. For example, if a post-processing work (for example, paper folding) is scheduled and it is appropriate to perform printing in the short-edge feed type, even though the print work for the print data is set to a double-sided print mode and thus it is set to feed the papers in the long-edge feed type, the user interface unit 240 provides an input window for the user to reset the feed type. On the other hand, the user interface unit 240 may provide a warning window for warning to the user, so that the user can select whether to change the feed type.

The sensing unit 290 senses the loading state of papers that includes whether papers are loaded on the first loading unit 231 and the second loading unit 232 and the number of sheets.

The control unit 280 may control the first loading unit 231 or the second loading unit 232 to feed papers in accordance with the print mode set through the user interface unit 240.

The control unit 280 may control the paper feed type in accordance with the paper loading state of the first loading unit 231 and the second loading unit 232, which is sensed by the sensing unit 290.

The control unit 280 may control the first loading unit 231 or the second loading unit 232 to feed the papers in accordance with whether the print mode for the print data is set to the double-sided print mode or the single-sided print mode. For example, upon the print mode being set to the double-sided print mode, the control unit 280 controls the second loading unit 232 to feed the printing paper in the long-edge feed mode direction, and upon the print mode being set to the single-sided print mode, the control unit 280 controls the first loading unit 231 to feed the printing paper in the short-edge feed mode direction.

The control unit 280 may control the first loading unit 231 or the second loading unit 232 to feed the papers in accordance with whether the print mode for the print data being set to the high image quality print mode or the low image quality print mode. For example, upon the print mode being set to the high image quality print mode, the control unit 280 controls the second loading unit 232 to feed the printing paper in the long-edge feed mode direction, and upon the print mode being set to the low image quality print mode, the control unit 280 controls the first loading unit 231 to feed the printing paper in the short-edge feed mode direction.

If the paper loading state of the second loading unit 232 is inappropriate to complete the printing in the long-edge feed mode, although the print mode for the print data is set to the double-sided print mode or the high quality print mode is set, the control unit 280 may control the first loading unit 231 to feed the papers in the short-edge feed mode. The paper loading state of the second loading unit 232 may be is inappropriate to complete the printing in the long-edge feed mode, for example, where there is no paper loaded in the second loading unit 232 or there are insufficient papers to complete the corresponding printing.

If at least one paper loading state of the first loading unit 231 and the second loading unit 232 is inappropriate to complete the corresponding print work, the control unit 280 may control the notification unit to notify the user of such a state.

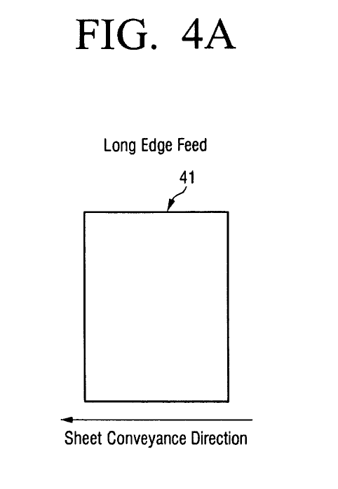

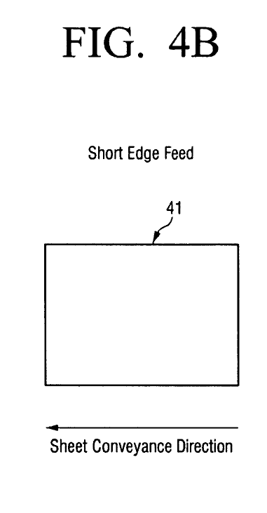

FIGS. 4A and 4B illustrate feed types according to an exemplary embodiment of the present disclosure.

As illustrated in FIG. 4A, the long-edge feed type is a type of feeding of sheets using the long-side of the sheet 41 as the front-side in a sheet conveyance direction.

As illustrated in FIG. 4B, the short-edge feed type is a type of feeding papers using the short-side of the sheet 41 as the front-side in a sheet conveyance direction.

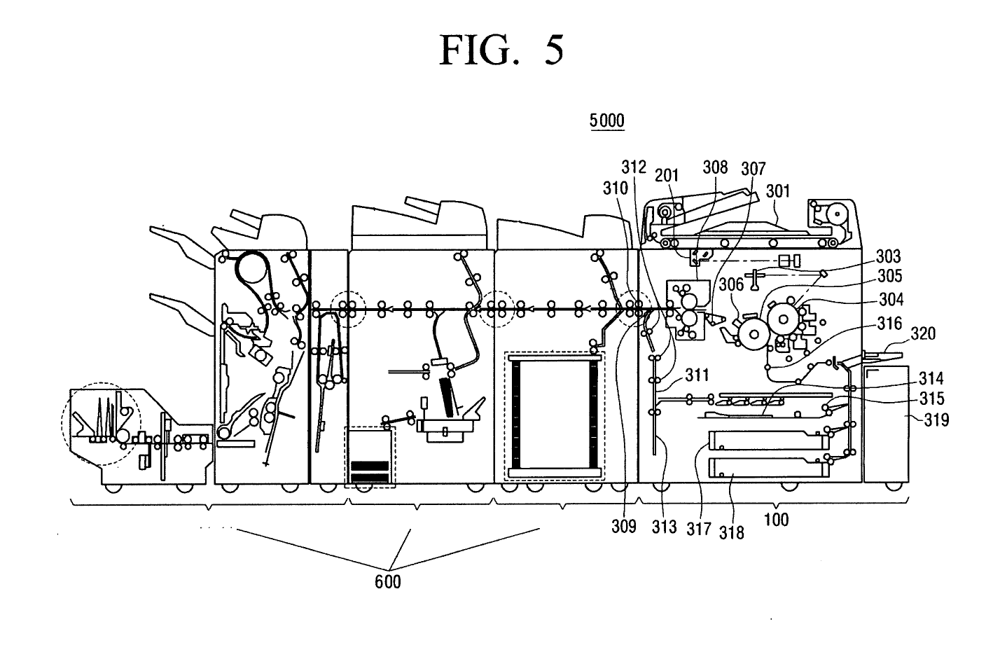

FIG. 5 illustrates an image forming apparatus according to an exemplary embodiment of the present disclosure.

Referring to FIG. 5, a printing system 5000 may be implemented to include an image forming apparatus 500 and a paper processing apparatus 600.

The image forming apparatus 500 may be implemented by a multifunction peripheral having multiple functions including a copying function, a printer function, and a facsimile function. It is also possible that the image forming apparatus 500 is implemented by a single-function type printing device having only a copying function, a printer function, or a facsimile function. According to an exemplary embodiment, the printing device 500 may be implemented by the image forming apparatus as illustrated in FIGS. 2 and 3.

The image forming apparatus 500 may be implemented as a device that is connected to a paper conveyance path and is capable of sequentially processing the papers.

An automatic document conveyance device (ADF) 301 of the image forming apparatus 500 separates document bundles that are put on the loading surface of the document tray in the order of their pages or numbers from the first page of the document, and conveys the document bundles on a glass of a document holder, so that the scanner unit 201 scans and reads the documents.

The scanner unit 201 reads an image of the document that is conveyed on the glass of the document holder, and converts the image into image data according to a CCD. A polygon mirror 303 receives laser light incident thereto that is modulated according to the image data, and irradiates a photosensitive drum 304 with the scanning light that is reflected by a reflection mirror.

A latent image formed on the photosensitive drum is developed by toner, and a toner image is transferred to the paper attached to a transfer drum 305. By sequentially performing this series of image forming processes with respect to yellow (Y), magenta (M), cyan (C), and black (K) toners, a full color image is transferred to the paper. In this exemplary embodiment of the present disclosure, a rotary type development system has been explained. However, the present disclosure may be widely adopted in other printing systems such as a tandem type development system and the like.

The paper on the transfer drum, onto which a full color image is transferred, may be separated from the transfer drum, and conveyed to a fuser 308 along a conveyance unit 307 before the fusing.

The fuser 308 includes a roller and a belt, and has a built-in heat source such as a halogen heater to fuse the toner on the paper, to which the toner image is transferred, by heat and pressure.

A delivery flapper 309 is movable around a moving shaft, and determines the conveyance direction of the paper. When the delivery flapper is rotated clockwise as shown in the drawing, the paper is straightly conveyed, and is delivered to the outside of the apparatus along a delivery roller 310.

The control unit 205 controls the print device to execute the single-sided printing according to the above-described series of sequences.

In forming an image on both sides of the paper, the delivery flapper is rotated counterclockwise, and the paper changes its direction downward and is conveyed to a double-sided conveyance unit. The double-sided conveyance unit includes a reverse flapper 311, a reverse roller 312, a reverse guide 313, and a double-sided conveyance tray 314. The reverse flapper 311 is rotated around the rotating shaft to determine the conveyance direction of the paper.

In processing the double-sided print work, the control unit 205 controls the printer 203 to print on a first surface of the paper, and controls the reverse roller 312 to send the paper to the reverse guide. The control unit 205 once stops the rotation of the reverse roller in a state where the rear end of the paper is held by the reverse roller 312, and then rotates the reverse flapper 311 clockwise as shown in the drawing to rotate the reverse roller in a reverse direction. Accordingly, the control unit operates to reverse and convey the paper to the double-sided tray 314 with the rear end and the front end of the paper reversed with each other.

The paper is loaded on the double-sided tray 314, and then is conveyed toward a regist roller 316 once again by a re-feeder roller 315. The paper is conveyed in a state where the opposite surface to the first surface faces the photosensitive drum.

An image is transferred, formed, and then fused onto a second surface of the paper, and then is delivered out of the print device.

The control unit 205 controls the print device to perform the double-sided printing according to the above-described series of operations.

In the double-sided print mode, unlike the single-sided printing, a series of sequences for reversing and re-conveying the paper is added to the single-sided printing, and thus more printing time is required in comparison to the single-sided printing.

The image forming apparatus 100 has a feeder unit that can receive paper required for the printing process. The feeder unit may include feeder cassettes 317 and 318, a feeder deck 319, and a manual tray 320.

The feeder cassette and the feeder deck include tap papers that are used in the exemplary embodiment of the present disclosure, and can set various kinds of papers including special papers having different size and material.

The paper processing apparatus 600 uses a paper conveyance path that is connected from an upper side device to a lower side device, and may be implemented in a form that can optionally connected various kinds of devices, through which papers can be conveyed. Each paper processing apparatus 600 may be provided with a paper delivery unit, and a user can take out printed bookbinding products of which paper processing has been completed from the delivery unit of the paper processing apparatus.

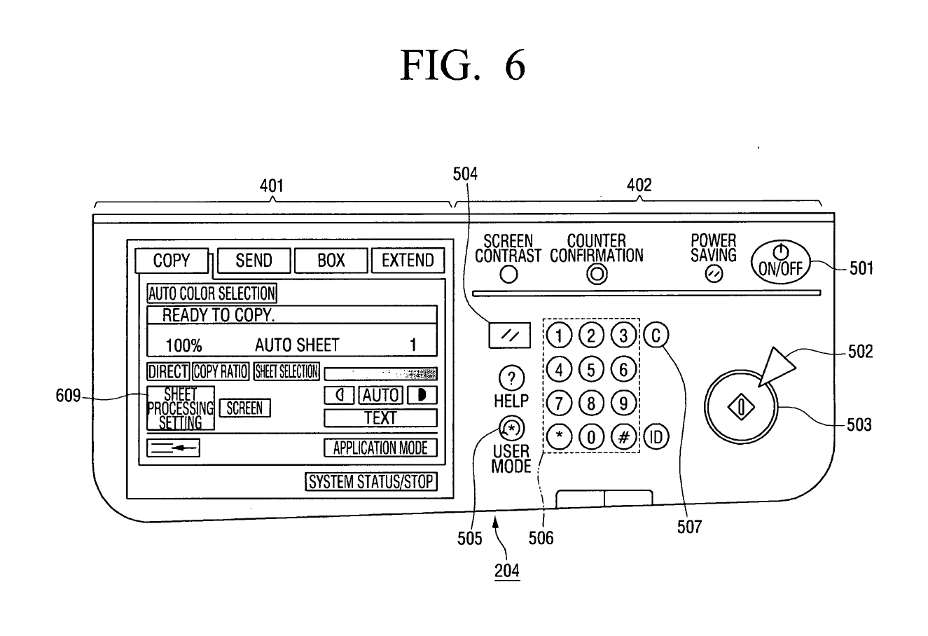

The control unit 205 may receive user's paper processing execution commands, together with a print execution command, from paper processing candidates that can operate as paper processing apparatuses connected to the printing device using the operation unit 204 as illustrated in FIG. 6.

The operation unit 204 includes a touch panel unit 401 and a key input unit 402. The control unit 205 controls the printing system 5000 to perform various kinds of processes based on user commands that are received using various kinds of screens displayed on the touch panel unit 401 or using the key input unit 402.

Through the operation unit 204, the user can command various kinds of processes, and for example, can operate whether to perform the double-sided printing or the single-sided printing. In the case of the double-sided printing, the control unit 205 automatically sets the long-edge feed mode, and displays whether papers required for the printing are set to be conveyed in the long-edge feed type on the touch panel unit 401. The control unit 205 may calculate and display the time required to convey the paper in the long-edge feed mode and in the short-edge feed mode. If papers that can be conveyed in the long-edge feed mode are not set in the cassette, the control unit may make the user move the papers.

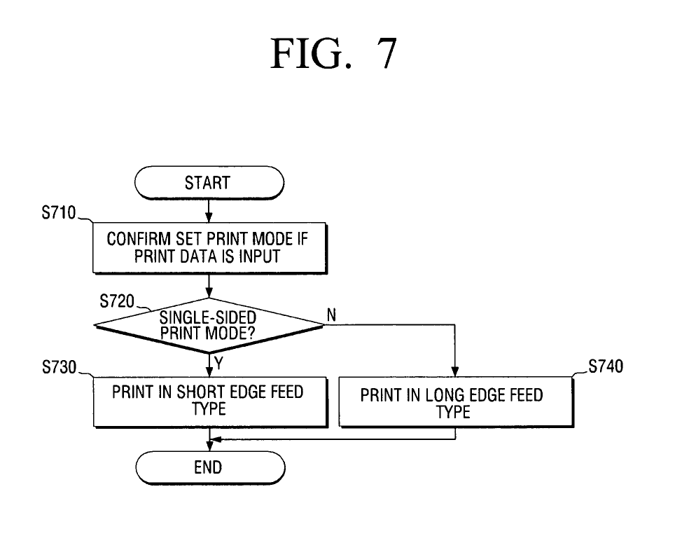

FIG. 7 illustrates a method for controlling an image forming apparatus according to an exemplary embodiment of the present disclosure.

According to a method for controlling an image forming apparatus as illustrated in FIG. 7, if print data is input, a print mode set for the print data is confirmed (S710) as to whether the print mode is a single-sided print mode or a double-sided print mode.

If the print mode set for the print data is the single-sided print mode (“Y” in S720), the printing is performed by feeding the paper in a short-edge feed type (S730).

If the print mode set for the print data is the double-sided print mode (“N” in S720), the printing is performed by feeding the paper in a long-edge feed type (S740).

However, the method for controlling the image forming apparatus according to an exemplary embodiment of the present disclosure is not limited to the configuration as in the flowchart of FIG. 7, and a quick conveyance mode may be selected in accordance with the user's selection of a quick conveyance mode or in accordance with the state and the number of papers loaded on the cassette. That is, in the single-sided print mode, the paper may be quickly conveyed in the short-edge feed mode, but according to circumstances, the papers may be quickly conveyed in the long-edge feed mode upon the user having selected the long-edge feed mode, the papers are loaded so that they can be quickly conveyed in the short-edge feed mode, or the number of sheets remaining in the cassette is smaller than the number of sheets for the printing work.

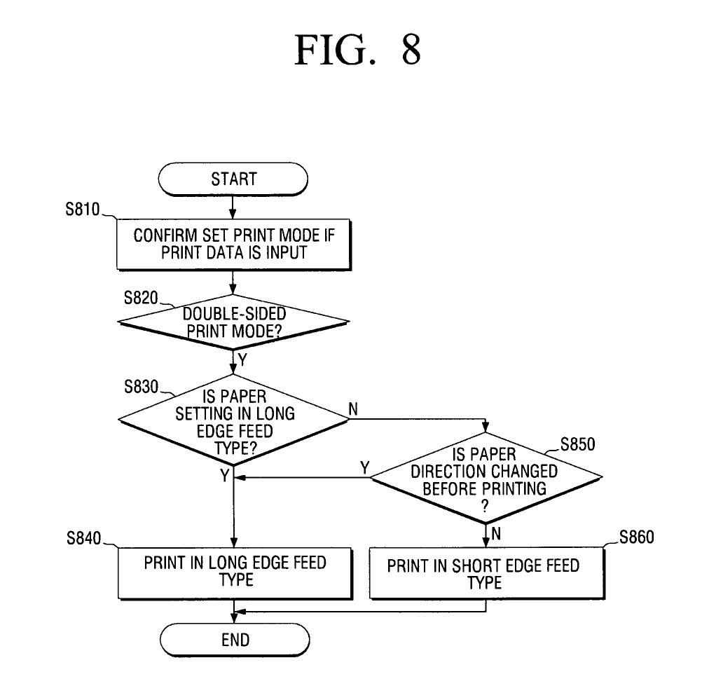

FIG. 8 illustrates a method for controlling an image forming apparatus according to another exemplary embodiment of the present disclosure.

According to a method for controlling an image forming apparatus as illustrated in FIG. 8, if print data is input, a print mode set for the print data is confirmed (S810) as whether the print mode is a single-sided print mode or a double-sided print mode.

If the print mode set for the print data is the double-sided print mode (“Y” in S820), it is confirmed whether the paper to be fed is set in the long-edge feed type (S830).

If the paper to be fed is set in the long-edge feed type (“Y” in S830), the printing is performed by feeding the paper in a long-edge feed type (S840).

If the paper to be fed is not set in the long-edge feed type (“N” in S830), that is, if the paper to be fed is set in the short-edge feed type, it is confirmed whether a user changes the paper feed direction before printing (S850).

In the case of changing the paper feed direction (“Y” in S850), that is, if the paper feed direction is changed to the long-edge feed type, the printing is performed by feeding the paper in the changed long-edge feed type (S840). In this case, the user is notified of the change of the paper feeding, and thus changes the paper feed direction of the loaded papers.

If the paper feed direction is not changed (“N” in S850), that is, if the paper feed direction is kept the short-edge feed type, the printing is performed in the short-edge feed type (S860). In this case, the user is notified of the change of the paper feeding, but refuses to change the paper feed direction.

Although the long-edge feed type or the short-edge feed type may be determined according to whether the print mode is the double-sided print mode or the single-sided print mode as described above, the paper feed type may also be adjusted in accordance with the post-processing to be performed or the user's setting.

Although in the exemplary embodiments as illustrated in FIGS. 7 and 8, the print mode is the double-sided print mode and the single-sided print mode, the same method can be applied upon the print mode being the high image quality/low image quality mode. The same method can be applied to diverse print modes that exert an influence on the print speed.

According to the present disclosure as described above, the feed type may be determined as the short-edge print mode or the long-edge print mode according to whether the print mode set during the print work is the double-sided print mode or the single-sided print mode, and thus, the user receives feed-back on a degree the printing efficiency is improved.

Further, according to an aspect of the embodiments, any combinations of the described features, functions and/or operations can be provided. The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. An image forming apparatus comprising:
an input unit receiving an input of print data;
a print unit performing printing of the input print data;
a feeder unit feeding a printing paper to the print unit; and
a control unit controlling the feeder unit to feed the printing paper in a long-edge feed type or a short-edge feed type in accordance with a print mode set for the print data.

2. The image forming apparatus as claimed in claim 1, wherein the control unit controls the feeder unit to feed the printing paper in the long-edge feed type upon the print mode set for the print data being a double-sided print mode and to feed the printing paper in the short-edge feed type upon the print mode set for the print data being a single-sided print mode.

3. The image forming apparatus as claimed in claim 2, wherein the control unit controls the feeder unit to feed the printing paper in the long-edge feed type upon the print mode set for the print data being a high resolution print mode and to feed the printing paper in the short-edge feed type upon the print mode set for the print data being a low resolution print mode.

4. The image forming apparatus as claimed in claim 2, further comprising a user interface unit providing user information on at least one of a first required time for performing printing by feeding the printing paper in the short-edge feed type, a second required time for performing printing by feeding the printing paper in the long-edge feed type, and comparison data of the first required time and the second required time, in performing the printing of the print data.

5. The image forming apparatus as claimed in claim 2, further comprising a notification unit notifying a user that a paper setting state of the feeder unit is unfit for completing the printing in a feed type that corresponds to the set print mode if the paper setting state is unfit for completing the printing.

6. An image forming apparatus comprising:
an input unit receiving an input of print data;
a user interface unit for setting a print mode for the print data;
a print unit performing printing of the print data in accordance with a print mode set for the print data;
a first loading unit loading papers being fed in a short-edge feed type;
a second loading unit loading papers being fed in a long-edge feed type; and
a control unit respectively controlling the first loading unit or the second loading unit to feed the papers according to whether the set print mode is a double-sided print mode or a single-sided print mode.

7. The image forming apparatus as claimed in claim 6, wherein the control unit controls the second loading unit to feed the papers upon the print mode for the print data being set to a double-sided print mode, and controls the first lading unit to feed the papers upon the print mode for the print data being set to a single-sided print mode.

8. The image forming apparatus as claimed in claim 7, further comprising a sensor unit sensing a paper loading state that includes at least one of whether the papers are loaded on at least one of the first loading unit and the second loading unit and the number of the papers;
wherein the control unit includes a notification unit notifying a user that a paper loading state of at least one of the first loading unit and the second loading unit is unfit for completing the corresponding printing work if the paper loading state is unfit for completing the printing work.

9. The image forming apparatus as claimed in claim 6, wherein the user interface unit provides a display window that provides user information on at least one of a first required time for the first loading unit to perform printing by feeding the paper, a second required time for the second loading unit to perform printing by feeding the paper, and comparison data of the first required time and the second required time, in performing the printing of the print data.

10. The image forming apparatus as claimed in claim 7, wherein the user interface unit provides an input window for resetting a feed type to the short-edge feed type or the long-edge feed type based on other printing works that include post-processing upon the printing work for the print data being set to the double-sided print mode or the single-sided print mode.

11. A method for controlling an image forming apparatus comprising:
receiving an input of print data;
confirming a print mode set for the print data; and
feeding a printing paper in a long-edge feed type or a short-edge feed type in accordance with the print mode set for the print data.

12. The method for controlling an image forming apparatus as claimed in claim 11, wherein the feeding operation feeds the printing paper in the long-edge feed type upon the print mode set for the print data is a double-sided print mode and feeds the printing paper in the short-edge feed type upon the print mode set for the print data is a single-sided print mode.

13. The method for controlling an image forming apparatus as claimed in claim 11, wherein the feeding operation feeds the printing paper in the long-edge feed type upon the print mode set for the print data is a high resolution print mode and feeds the printing paper in the short-edge feed type upon the print mode set for the print data is a low resolution print mode.

14. The method for controlling an image forming apparatus as claimed in claim 12, further comprising providing user information on at least one of a first required time for performing printing by feeding the printing paper in the short-edge feed type, a second required time for performing printing by feeding the printing paper in the long-edge feed type, and comparison data of the first required time and the second required time, in performing the printing of the print data.

15. The method for controlling an image forming apparatus as claimed in claim 12, further comprising notifying a user that a paper setting state of the feeder unit is unfit for completing the printing in a feed type that corresponds to the set print mode if the paper setting state is unfit for completing the printing.

16. A method for controlling an image forming apparatus comprising:
receiving an input of print data;
a user interface unit for setting a print mode for the print data;
setting a print mode for the print data;
determining whether a first loading unit that loads papers being fed in a short-edge feed type or a second loading unit that loads papers being fed in a long-edge feed type feeds the papers according to whether the set print mode is a double-sided print mode or a single-sided print mode; and
performing printing in accordance with the determined feed type.

17. The method for controlling an image forming apparatus as claimed in claim 16, wherein the determination operation determines that the second loading unit feeds the papers upon the print mode for the print data being set to a double-sided print mode, and the first lading unit feeds the papers upon the print mode for the print data being set to a single-sided print mode.

18. The method for controlling an image forming apparatus as claimed in claim 17, further comprising:
sensing a paper loading state that includes at least one of whether the papers are loaded on at least one of the first loading unit and the second loading unit and the number of the papers; and
notifying a user that a paper loading state of at least one of the first loading unit and the second loading unit is unfit for completing the corresponding printing work if the paper loading state is unfit for completing the printing work.

19. The method for controlling an image forming apparatus as claimed in claim 16, further comprising providing a display window that provides user information on at least one of a first required time for the first loading unit to perform printing by feeding the paper, a second required time for the second loading unit to perform printing by feeding the paper, and comparison data of the first required time and the second required time, in performing the printing of the print data.

20. The method for controlling an image forming apparatus as claimed in claim 17, further comprising providing an input window for resetting a feed type to the short-edge feed type or the long-edge feed type based on other printing works that include post-processing upon the printing work for the print data being set to the double-sided print mode or the single-sided print mode.
